(19) United States
(12) Patent Application Publication
(10) Pub. No.: US 2018/0252673 A1
(43) Pub. Date: Sep. 6, 2018

(54) Multi-Species Gas Constituent Sensor with Pulse Excitation Measurement

(71) Applicant: DELPHI TECHNOLOGIES IP LIMITED, ST. MICHAEL (BB)

(72) Inventors: Da Yu Wang, Troy, MI (US); David M. Racine, Davison, MI (US); Sheng Yao, Troy, MI (US)

(21) Appl. No.: 15/448,012

(22) Filed: Mar. 2, 2017

(51) Int. Cl. G01N 27/41; G01N 27/406; G01N 27/407

(52) U.S. Cl. CPC G01N 27/41; G01N 27/4073; G01N 27/4075; G01N 27/4067

(57) ABSTRACT

A sensor system includes a common gas chamber and a reference gas chamber that respectively receive an exhaust gas and a reference gas. A Nernst cell is exposed to the common gas chamber and the reference air chamber and provides a reference signal indicative of an oxygen difference between the common gas chamber and the reference gas chamber. An oxygen electrochemical pump cell is exposed to the common gas chamber to provide an oxygen signal indicative of an oxygen-only concentration. A gas electrochemical cell is exposed to the common gas chamber and the reference gas chamber and provides a gas signal indicative of a gas concentration. A processor includes a pulsation module that provides a positive and a negative excitation voltage to the gas electrochemical cell for a duration and that are each followed by a decay curve indicative of the gas concentration.

### BACKGROUND

The disclosure relates to an exhaust gas sensor capable of sensing at least oxygen, oxides of nitrogen (NOx), and ammonia (NH3) content.

Exhaust gas generated by combustion of fossil fuels in furnaces, ovens, and engines contain, for example, NOx, unburned hydrocarbons (HC), and carbon monoxide (CO). Some automotive vehicles utilize various pollution-control after treatment devices such as NOx absorber(s), selective catalytic reduction (SCR) catalyst(s), and/or the like, to reduce NOx emissions. NOx reduction is accomplished by using NH3, which can be generated from the reaction of urea with steam. In order for SCR catalysts to function efficiently and to avoid pollution breakthrough, a control system is used to manage the dosing of NH3. Typically, a NOx sensor is mounted at the engine out location to monitor the amount of NOx generated. Another NOx sensor mounted at the end of the SCR unit to monitor the left-over NOx as well as slip NH3 (measured as NOx) afterwards. Both NOx sensors signals are fed into a controller to control NH3 dosing for maximizing the efficiency of NOx reduction of the SCR unit.

Current NOx sensors on the market use electrochemical pump cell technology. Typically NOx sensors are built with two or three in-cascade electrochemical pumping cells requiring eight lead wires for sensor control and operation, which is expensive and complicated to produce. There also are some performance limitations to current NOx sensors, such as cross-interference from other gases and loss of accuracy in its life-time performance. Trying to combine more sensing features into the device (such as NH3, NO to NO2 ratio sensing) would require more than eight wires, adding more complexity and difficulty to its packaging and manufacture. These issues are not in line with customer expectations.

### SUMMARY

In one exemplary embodiment, a sensor system includes multiple layers that include a common gas chamber and a reference gas chamber respectively configured to receive an exhaust gas and a reference gas. A Nernst cell is exposed to the common gas chamber and the reference air chamber. The Nernst cell is configured to provide a reference signal indicative of an oxygen difference between the common gas chamber and the reference gas chamber. An oxygen electrochemical pump cell is exposed to the common gas chamber and is configured to provide an oxygen signal indicative of an oxygen only concentration. A gas electrochemical cell is exposed to the common gas chamber and the reference gas chamber and is configured to provide a gas signal indicative of a gas concentration. A processor is in communication with the Nernst cell and the oxygen electrochemical pump cells. The processor includes a pulsation module configured to provide a positive and a negative excitation voltage to the gas electrochemical cell for a duration. Each of the positive and the negative excitation voltages are followed by a decay curve indicative of the gas concentration.

In a further embodiment of the above, the duration is in a range of 5-50 msec. An interval between the positive and the negative excitation voltages is in a range of 100 msec to 10 sec.

In a further embodiment of any of the above, the excitation voltage is in a range of +/−2-2.5 V and is no larger than an electrochemical electrolysis voltage of the gas electrochemical pump cell material system at a fixed frequency.

In a further embodiment of any of the above, the oxygen pump electrode in the common gas chamber uses electrode materials that least dissociate oxygen from NOx electrolytically.

In a further embodiment of any of the above, the oxygen electrochemical pump cell includes an oxygen-only pump electrode in the common gas chamber supported on one side of a first layer of the multiple layers. A counter oxygen pump electrode is supported on an opposite side of the one side of the first layer.

In a further embodiment of any of the above, the Nernst cell includes EMF oxygen sensing electrode and reference electrode arranged on opposing sides of a second layer of the multiple layers. The EMF oxygen sensing electrode is arranged in the common gas chamber and the reference electrode is arranged in the reference gas chamber.

In a further embodiment of any of the above, the oxygen-only pump electrode and the EMF oxygen sensing electrode share a ground.

In a further embodiment of any of the above, a heater is arranged adjacent to the Nernst cell. The processor is configured to provide a fixed frequency excitation voltage feed into the Nernst cell to obtain the electrolyte impedance between the EMF and reference electrodes and provide a feedback control signal to modulate electrical power to the heater.

In a further embodiment of any of the above, the processor is configured to control a voltage to the oxygen-only electrochemical pump cell based upon the reference signal from the Nernst cell.

In a further embodiment of any of the above, a gas diffusion-limiting aperture is provided in at least one of the multiple layers and is in fluid communication with the common gas chamber. The gas diffusion-limiting aperture is configured to regulate an amount of exhaust gas into the common gas chamber.

In a further embodiment of any of the above, the common gas chamber is configured to have a constant ratio of nitrogen monoxide and nitrogen dioxide.

In a further embodiment of any of the above, common gas chamber is configured to be free from hydrocarbons and carbon monoxide.

In a further embodiment of any of the above, the gas diffusion-limiting aperture includes precious metals as catalysts.

In a further embodiment of any of the above, the counter oxygen pump electrode of the oxygen pump cell is exposed to the exhaust or air reference gas.

In a further embodiment of any of the above, a ceramic metal heater is arranged in the multiple layers adjacent to the Nernst cell. The processor is configured to measure an initial drop of voltage in the Nernst cell or the electrochemical cell immediately after the excitation voltage. The voltage drop corresponding to an ohmic drop in electrolyte impedance that is used by the processor to modulate power to the ceramic metal heater.

In a further embodiment of any of the above, a wire pigtail with six wires is electrically connected to the Nernst cell, the oxygen electrochemical pump cell and the gas electrochemical cell and the heater.

In a further embodiment of any of the above, a heater is arranged in the multiple layers arranged adjacent to the Nernst cell. The sensing element includes an ammonia electrochemical mixed potential cell and a nitrogen dioxide electrochemical mixed potential cell arranged in the multiple layers and respectively configured to provide NH3 and NO2 signals.

In a further embodiment of any of the above, a wire pigtail with only eight wires is electrically connected to the sensor element.

In a further embodiment of any of the above, the processor is configured to output a difference between the NO2 and NOx signals and provide a nitrogen monoxide concentration.

In a further embodiment of any of the above, a controller is in communication with the process and is configured to command at least one of a fuel system, an emissions system, and an engine control device in response to the NOx concentration.

### BRIEF DESCRIPTION OF THE DRAWINGS

The disclosure can be further understood by reference to the following detailed description when considered in connection with the accompanying drawings wherein:

FIG. 1 is a schematic view of an exhaust sensor system.

FIG. 2 is one example embodiment of an exhaust gas sensor, with an oxygen electrochemical pump cell and a gas electrochemical cell, in communication with a processor.

FIG. 3 is a first cross-sectional view through a sensing element of the exhaust gas sensor of FIG. 2.

FIG. 4 is a second cross-sectional view through the sensing element of the exhaust gas sensor of FIG. 2.

FIG. 5 is a box circuit diagram of portions of the exhaust gas sensor and the processor shown in FIG. 2.

FIG. 6 is another example embodiment of an exhaust gas sensor.

FIG. 7 is a graph illustrating pulsation control of an electrochemical cell and its resulting decay curve, which is indicative of a gas concentration.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

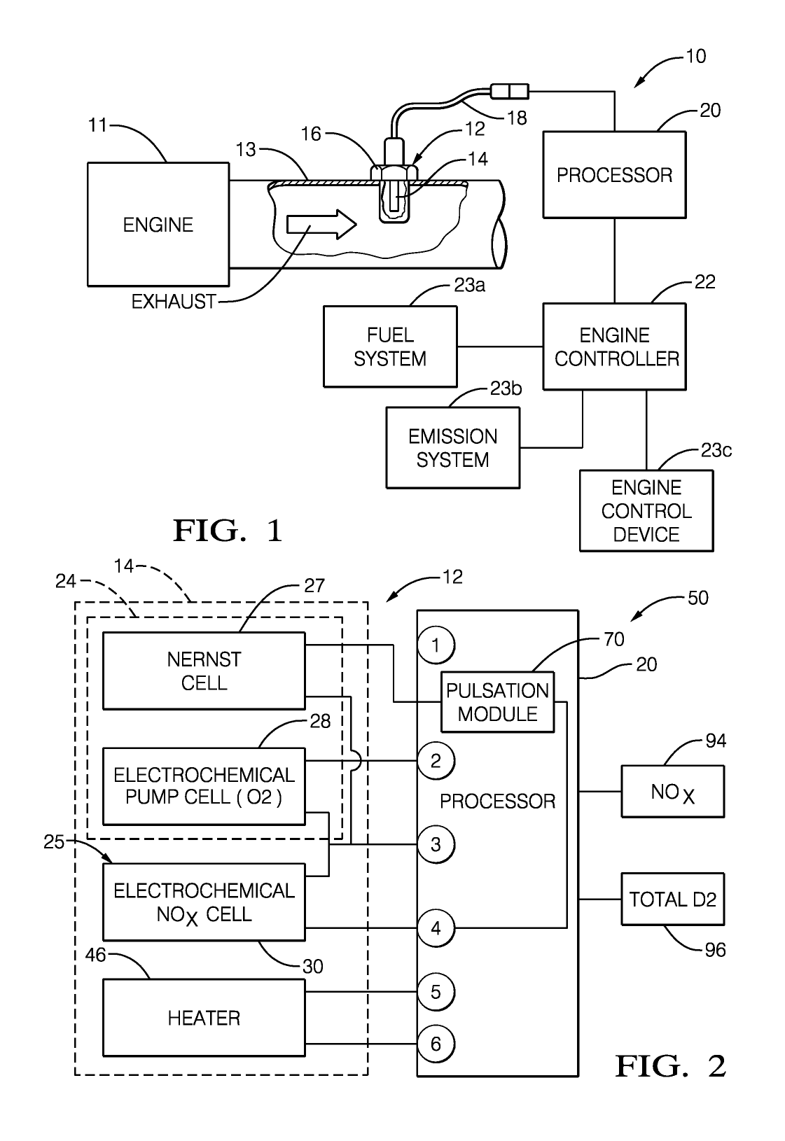

A sensor system 10 is schematically shown in FIG. 1. The system 10 includes an exhaust gas sensor 12 connected to a processor 20 by a wire pigtail 18. The exhaust gas sensor 12 is arranged in an exhaust system 13 downstream from an engine 11 to maintain engine operating efficiency and low vehicle emissions by sensing the byproducts of engine combustion.

A sensing element 14 is arranged within a housing 16 of the exhaust gas sensor 12 that is grounded to the exhaust system 13. In one disclosed embodiment, the sensing element 14 outputs signals indicative of oxygen (O2) concentration (or air/fuel ratio) and total oxides of nitrogen (NOx) concentration, which are then received and interpreted by the processor 20. The relevant exhaust gas constituent information is provided to an engine controller 22, which may command various vehicle systems, such as a fuel system 23a, an emissions system 23b, and/or engine control device 23c. It should be understood that the processor 20 and controller 22 may be integrated with one another, or they may be separate, discrete units remotely located from one another.

Referring to FIG. 2, the sensing element 14 includes a wide range air/fuel ratio (WRAF) sensor 24 and an electrochemical NOx sensor 25 arranged amongst layers of material to provide a single sensor structure using thick- or thin-film multi-layer ceramic technology. The WRAF sensor 24 senses the air/fuel ratio of the engine exhaust and provides a constant oxygen gas environment that is free of carbon monoxide (CO) and hydrocarbons (HC), which creates a constant nitrogen monoxide (NO) to nitrogen dioxide (NO2) ratio at a constant temperature. The electrochemical NOx sensor 25 senses the total NOx under the conditions created by the WRAF sensor 24.

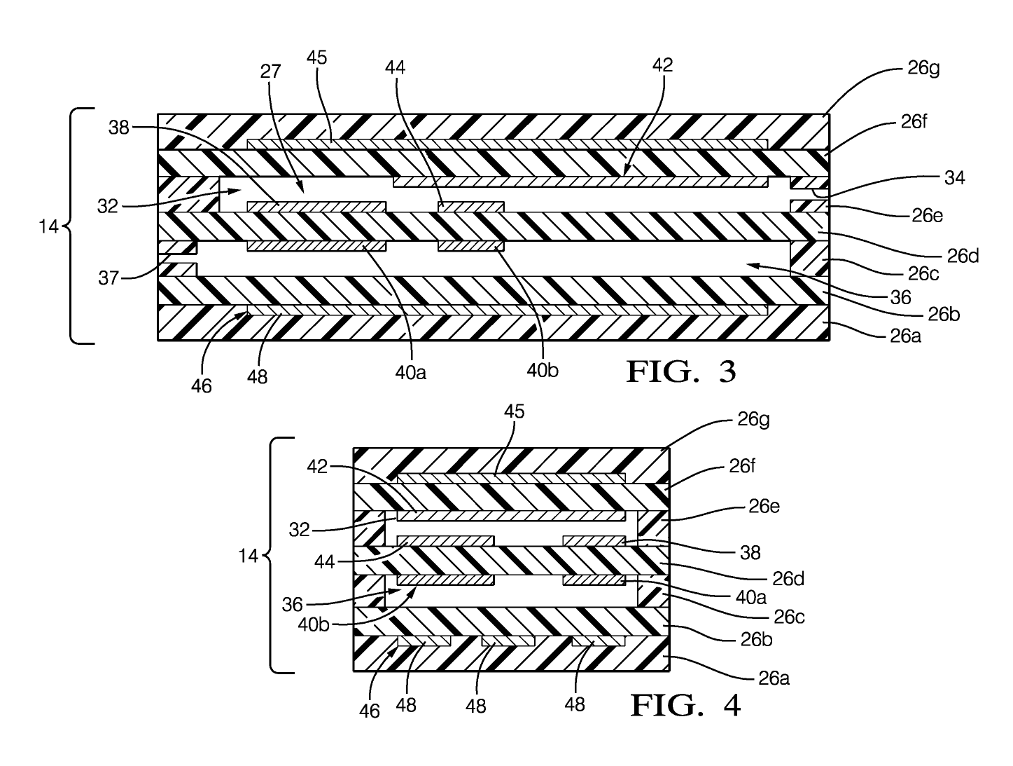

The WRAF sensor 24 includes a Nernst cell 27 and an oxygen-only electrochemical pump cell 28 that detects oxygen in a common gas chamber 32 and in the exhaust gas (FIGS. 3 and 4). The NOx sensor 25 includes a NOx electrochemical cell 30 that detects NOx in the common gas chamber 32 using a pulsation method. Additional gas sensing cells (such as mixed potential cells) may be provided in the sensing element 14, for example, for sensing nitrogen dioxide (NO2), ammonia (NH3) and/or hydrocarbons (HC), which can be used for controlling the dispensing of urea and monitoring the effectiveness of the after treatment system.

Both WRAF and NOx sensors 24, and 25 share a common gas chamber 32, as shown schematically in FIGS. 3 and 4. The common gas chamber 32 has a gas diffusion-limiting aperture 34 connecting the common gas chamber 32 to the engine exhaust atmosphere. The gas diffusion-limiting aperture 34 may have a precious metal catalyst (i.e., gold, silver, platinum and their alloys) to oxidize unburned CO and HC, which allows NOx to reach its thermodynamic ratio of NO and NO2 once inside the common gas chamber 32. The operation of the WRAF sensor 24 is to control the gas atmosphere within the common gas chamber 32 to a fixed oxygen concentration against a reference gas or air. Since the WRAF sensor 24 provides a stable gas environment within the common gas chamber 32, the NOx sensor 25 may then provide an accurate NOx sensing signal.

Returning to FIG. 2, with the example sensor 12, six wires (indicated by circled numerals 1-6) connect the sensing element 14 to the processor 20, which provides a simpler, less costly configuration as compared to prior art NOx sensors. The processor 20 provides outputs 50 to the controller 22 relating to at least oxygen (or air/fuel ratio) and NOx presence in the exhaust gas.

A heater 46 is powered by two of the six wires and is used to quickly heat the sensing tip of sensing element 14 to a desired operating temperature to provide more immediate gas constituent sensing. As shown in FIGS. 3 and 4, the heater 46 is made of a precious metal based serpentine 48 printed between two electrically insulated ceramic layers 26a, 26b. The layers may be made of alumina, silica and/or their alloys and provides electrical isolation at elevated temperatures typical during sensor operation. The serpentine 48 at the sensing tip of the sensing element has two electrical leads connected to two pads at the end of the ceramic substrate where modulated voltage may be fed in from a processor 20 or controller 22 to control heating of the sensing element 14.

The Nernst cell 27 and the oxygen electrochemical pump cell 28 share the common gas chamber 32. The Nernst cell includes an electromotive force (EMF) electrode 38 located within the common gas chamber 32 and a reference electrode 40a exposed to air or a reference gas supplied by an inlet 37 in a layer 26c to a reference air chamber 36. The EMF electrode 38 and the reference electrode 40a are on opposite sides of a layer 26d of solid oxide electrolyte, for example, an aliovalent doped zirconium oxide material.

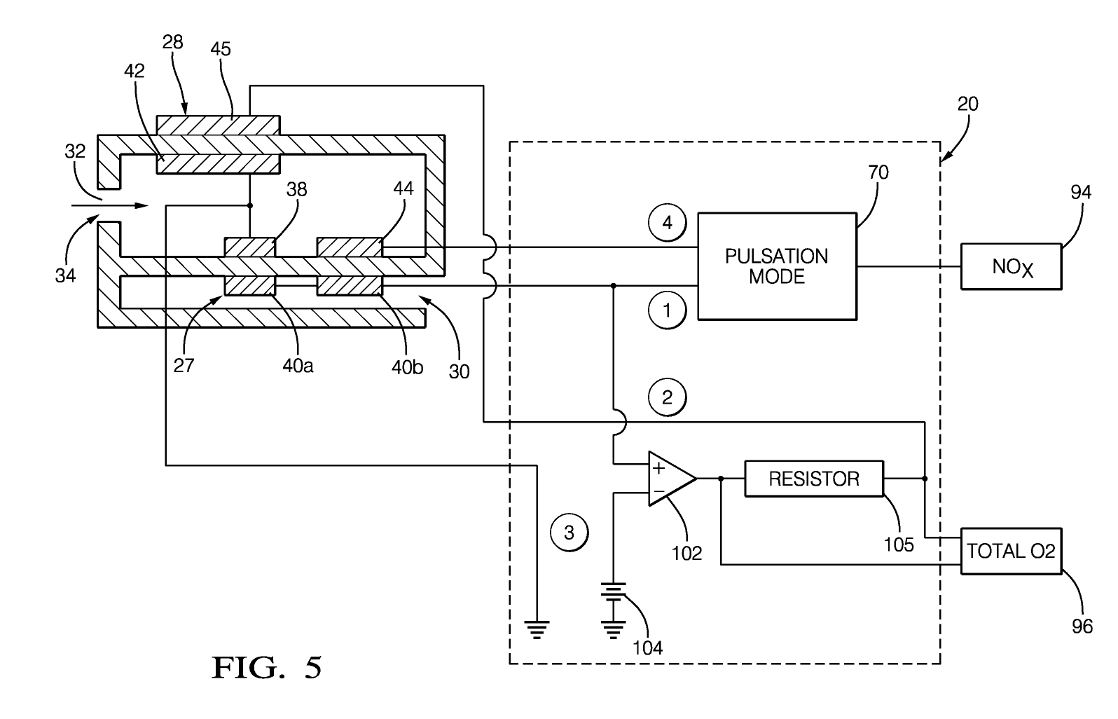

The oxygen electrochemical pump cell 28 has an oxygen-only pump electrode 42 exposed to the common gas chamber 32, which is bounded by layer 26e. A counter oxygen pump electrode 45 is separated by and supported on a solid oxide electrolyte layer 26f, such as partially stabilized or fully stabilized zirconia doped with alumina or yttria. The counter oxygen pump electrode 45 may be exposed to the ambient exhaust gas atmosphere through porous poison protection layer 26g, or air, or the same reference gas as the Nernst cell 27. The oxygen electrode 42 and the EMF electrode 38 of the Nernst cell 27 may be electrically connected together (wire 3 in FIGS. 2 and 5). The electrolyte layers may be common or separate.

The oxygen-only pump electrodes 42 of the oxygen electrochemical pump cell 28 are made of a gold, gold alloy, gold-platinum or platinum-rhodium-gold-palladium alloys that will pump out oxygen and least dissociate oxygen from NOx in the common gas chamber 32. The rest of the electrodes of the Nernst cell 27, the oxygen electrochemical pump cell 28 and the NOx electrochemical cell 30 are made of platinum, platinum-palladium, platinum-palladium-rhodium alloys. The electrode 44 of the NOx electrochemical cell 30 shares the common gas chamber 32 and shares the same electrolyte layer with the EMF electrode 38 of the Nernst cell 27. The counter electrode 40b of the NOx electrochemical cell 30 is exposed to the reference gas chamber and shares the electrolyte layer with the reference electrode 40a of the Nernst cell 27. The platinum-based electrodes 38, 42 and 44, and the precious metal catalyst containg aperture 34 within the common gas chamber 32 keep the gas free of HC, maintaining a constant NO to NO2 ratio of the total NOx gas being measured. The Nernst cell 27 and the oxygen electrochemical pump cell 28 electrodes may share the same electrolyte layer or have separate electrolyte layers. The electrochemical NOx sensor 25 may share the reference gas side electrode 44b and the reference gas electrode 40a of the Nernst cell 27 in common (wire 1 in FIGS. 2 and 5).

The Nernst cell 27, the oxygen electrochemical pump cell 28, and the NOx electrochemical cell 30 have leads connected to the pad area at the end of the sensing element 14. The processor 20 will read the EMF of the Nernst cell 27 and use it as a feedback loop signal to control the pump current to pump oxygen in or out of the common gas chamber 32 so that the EMF of the Nernst cell 27 will be kept at a constant value, which will be appreciated from the circuit diagram shown in FIG. 5. The pump current will be limited by the gas diffusion-limiting aperture 34 of the common gas chamber 32 and the limiting pump current is used to determine the oxygen concentration or the air/fuel ratio of the engine exhaust.

The Nernst cell 27 may be used as a temperature sensing cell also. The processor 20 uses fixed frequency excitation voltage feed into the Nernst cell 27 to obtain the electrolyte impedance between the EMF and reference electrodes 38, 40a and uses this impedance as a feedback control signal to modulate the electrical power to the heater 46 and maintain the sensing tip of sensing element 14 at a constant temperature.

The electrochemical NOx sensor 25 includes electrodes 44 (exposed to common gas chamber 32) and 40b (exposed to reference gas). The electrochemical NOx sensor 25 may share the same electrolyte layer of Nernst cell 27. Alternatively, the electrode complex impedance developed at the NOx electrode 44 and counter electrode 40b may be directly used for NOx sensing, which may be measured using fixed frequency AC polarization provided by the controller while the electrolyte impedance developed between the two electrodes, measured at high fixed frequency AC polarization may be used for temperature sensing to control the power to heat up the heater.

In the example shown in FIGS. 3 and 4, the oxygen-pump and NOx-sensing electrodes 42, 44 are shown arranged parallel longitudinally, but it should be understood that these electrodes may be arranged end-to-end instead, if desired.

The processor 20 and/or controller 22 have the circuitry to provide electrical power to the sensor with feedback loop control functions. The processor 20 is capable of reading the parameters memorized in EEPROM embedded in the sensor package and has microprocessor to operate the cells 27, 28, 30, to monitor the sensing signals and convert the sensing signals to gas compositions in % and ppm. The controller 22 may communicate with other sensors (CO2 sensor, pressure, temperature sensor), engine control module (ECM) or urea dispense controllers and exchange data for the purpose of engine control, exhaust after treatment control and onboard diagnostics (OBD).

An example block circuit 100 for the processor 20 is shown in FIG. 5. The four wires “Wire 1,” “Wire 2,” “Wire 3,” “Wire 4”, indicated by the circled numerals) 1-4 associated with the Nernst cell 27, electrochemical pump cell 28 and electrochemical NOx cell 30 in FIG. 2 are illustrated here connecting individual cell electrodes with corresponding circuit blocks. Wire 3 provides a ground.

Referring to FIGS. 2 and 5, the processor 20 provides outputs TOTAL O2 concentration of exhaust gas 96 (or air to fuel ratio of the exhaust after processing the pump current from WRAF sensor 24), NOx concentration 98 (after processing the sensing signal from NOx electrochemical cell 30). EMF electrode 38 of Nernst cell 27 and oxygen electrode 42 of oxygen electrochemical pump cell 28 share the same common gas chamber 32 with the gas-diffusion-limiting aperture 34 to communicate with ambient exhaust gas. Returning to FIG. 5, a signal from the Nernst cell 27 is provided by Wire 1 to an operational amplifier 102, which compares the EMF with a reference voltage signal, for example, 450 mV, from a reference voltage source 104. A pump voltage will be generated from operational amplifier 102 to oxygen pump electrode 45 (wire 2 in FIG. 5). The pump voltage will pump oxygen in and out of the common chamber 32 to minimize the voltage difference between the EMF of the Nernst cell 27 and the reference voltage 104. The pump current represents the limiting oxygen current which is a function of the exhaust oxygen concentration. The oxygen current can be measured from the voltage drop across a resistor 105 shown in FIG. 5, which can be converted to the total oxygen concentration or air to fuel ratio of the exhaust.

A pulsation module 70 in processor 20 is used to provide pulses of positive and negative short duration of excitation voltage to the electrochemical pumping cell 30 with an electrical amplitude no larger than the electrochemical electrolysis voltage of the zirconia-electrode material system at a fixed frequency. The pulsed excitation voltage is supplied to the electrodes 44 and 40b of the NOx electrochemical cell 30. The voltage excitation may last 5 msec to 50 msec, for example. The rest duration after each positive or negative excitation may be 100 msec to 10 sec. Both excitations may be symmetric except the polarity.

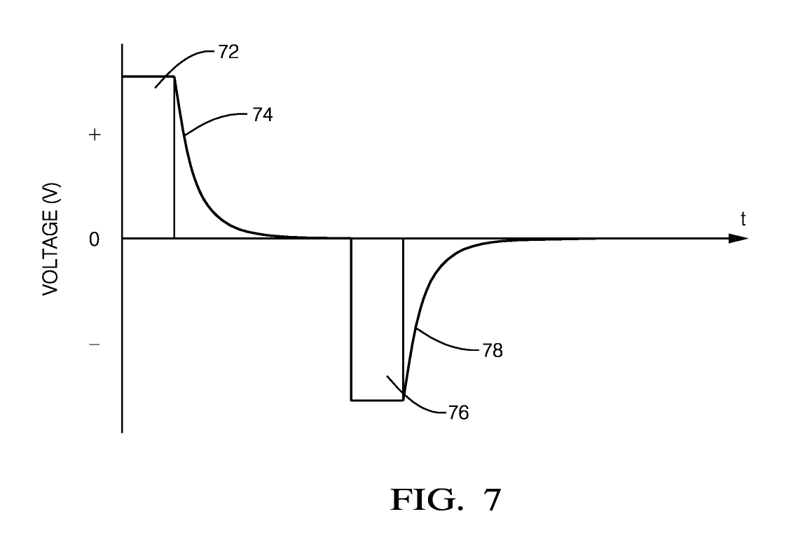

Referring to FIG. 7, for each positive and negative voltage excitation 72, 76, follows a duration time for the excited cell to recover. The ohmic drop will be decided by catching the voltage drop at a fixed duration right after the stop of the voltage excitation (1-10 msec for example). Positive or negative curve decay values or slopes 74, 78 may be used to detect the specific gas concentration. During the recovery time, no excitation voltage is applied to the cell, and the decay curve of the after-excitation is monitored by the processor 20. The initial drop of voltage between the electrode pairs immediately after the stop of excitation voltage represents the ohmic drop of the electrolyte impedance which may be detected by the processor 20 and used as a feedback signal to modulate the electrical power to the heater 46.

The subsequent decay curve of the electrode polarization contains the mixed-potential gas sensing information. One such approach is described in Fischer, S., Pohle, R., Farber B. Proch, R, Kaniuk, J., Fleischer, M. & Moos, R. (2010). Method for detection of NOx in exhaust gases by pulsed discharge measurements using standard zirconia-based lambda sensors. Sensors and Actuators B: Chemical, 147(2), pp. 780-785, which is incorporated herein by reference in its entirety. By measuring the electrical decay curve slopes, or values at the rest duration time against that of background gases without the presence of NOx, the concentration of the NOx sensing gas may be determined with the help of a calibration table which converts the slopes or decay curve value to the ppm of the gas. For example, to sense NOx, the positive decay curves output at NOx 94 may be used to determine the NOx concentration and the negative decay curves may be used to identify cross-interference effect. The excitation voltage may be controlled at 2-2.5 V. Other gases may be sensed in a similar manner.

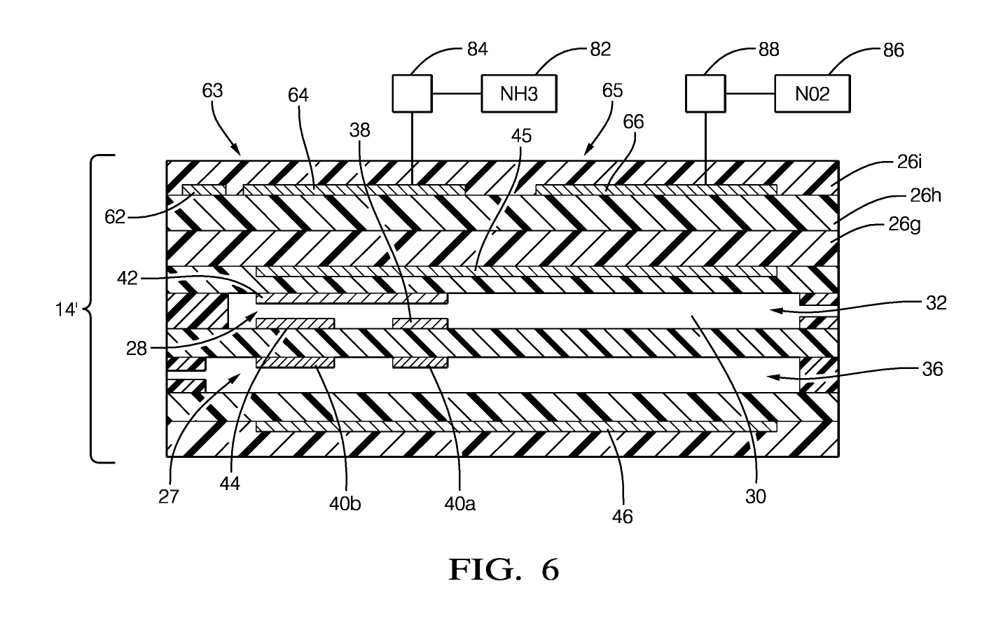

The disclosed six wire exhaust gas sensor may be built with additional sensing features. More cells may be provided in the separate electrolyte layers, as shown in FIG. 6, such that additional exhaust species could be measured or derived. For example, additional solid oxide electrolyte layers 26h, and insulation layer 26g may be added to the rest of the substrate while with proper size of gas chamber created on top of electrode 45 to allow free gas communication to the ambient exhaust gas. Of course, additional or fewer electrodes and layers may be provided.

The extra solid electrolyte layer will have two mixed potential gas sensing cells built on the surface of the electrolyte layer with their reference electrodes shared. All the electrodes of the two cells are exposed to the same ambient exhaust atmosphere.

The sensing element 14′ includes an ammonia (NH3) electrochemical mixed potential cell 63 and NO2 electrochemical mixed potential cell 65. The NH3 electrochemical mixed potential cell 63 has a common reference electrode 62 and a NH3 sensing electrode 64. The NO2 electrochemical mixed potential cell 65 is provided by a NO2 sensing electrode 66, which cooperates with the common reference electrode 62. Both NH3 and NO2 sensing cells use a mixed-potential principle for NH3 and NO2 sensing. The common reference electrode 62 may share the same common ground wire (Wire 3 in FIG. 5) as the EMF electrode 38 and oxygen-only pump electrode 42.

The common reference electrode 62 may be constructed with materials the same as reference electrode 40a. The NH3 electrode 64 may be constructed of NH3-suitable sensing materials, for example, bismuth vanadium oxide with magnesium oxide as an additive. The NO2 sensing electrode 66 may be made of NO2-suitable sensing materials, for example, manganese silicate materials with cobalt oxide, zinc oxide and/or alumina oxide as an additive.

The NH3 and NO2 sensing electrodes 64, 66 use two additional lead wires (a total of eight wires for sensor 14′) to communicate EMF sensing signals from the NH3 and NO2 electrochemical mixed potential cells 63, 65 to the processor 20.

The processor 20 may receive the NH3 sensing EMF signal from the NH3 sensing cell and utilize the onboard information of oxygen and NO2 (both gases have interference effect on the NH3 sensing EMF signal) to correct and convert the NH3 EMF signal into the NH3 signal in ppm. Water also has an interference effect and its concentration may be obtained from oxygen information through the air/fuel ratio relationship and correction may be done accordingly. The processor 20 may receive the NO2 sensing EMF signal from the NO2 sensing cell and utilize the onboard information of oxygen (oxygen gas has an interference effect on the NO2 sensing EMF signal) to correct and convert the NO2 EMF signal into the NO2 signal in ppm.

An HC electrochemical mixed potential cell may also be integrated into the sensing element 14′ in a manner similar to that described with respect to the NOx, NH3 and NO2 electrochemical pumping elements. The HC electrode may be constructed from suitable HC sensing materials, for example, zinc oxide, zinc-tin-oxide or any other materials that can sense HC with mixed potential principle.

Afterwards, the existing NOx information may be corrected with NH3 in ppm (6-wire device cannot tell the difference between NOx gas from the NH3 gas). The NO2 in ppm information in conjunction of the NH3-interference-free information of NOx may be used to provide NO in ppm. In this way, oxygen, A/F, NH3, NOx, NO, NO2, HC concentrations may be correctly sensed and reported to the controller 22 for control of the exhaust after treatment module or other control applications or onboard sensing applications.

The sensing elements 14, 14′ may be covered with a proper poison protection coating layer, which may be made of any known technology that may provide such protection function against the exhaust poisons. Catalytic chemicals may be added into the coating material to eliminate or decrease unwanted cross-interference effects from other exhaust constituents.

The sensing elements 14, 14′ may be packaged with any known packaging technology that would provide the element with mechanical, thermomechanical, and shock-vibrational impact protection. The package for the sensor 12 may include a multi-parameter-memory-chip (e.g., EEPROM chip) that stores calibration tables, conversion equations, conversion parameters, and temperature control parameters.

The disclosed sensor 12, which combines the reliability of pump cell technology, with its ability to create a specific atmosphere for NOx-sensing, and the NOx sensing pulsation modulation method based on silicon microelectronics technology enables a reduced number of lead wire (from eight to six) for NOx sensing. This permits more sensing functions into the existing sensor body with only a few wires, and makes it possible to manufacture a true combination sensor that may sense multiple gases in engine exhaust (oxygen, A/F, NH3, NO, NO2, NOx, HC). The disclosed sensor 12 is easier to produce with lower cost, while addressing some of the industry's concern with current pump cell NOx sensors performance. It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A sensor system comprising:
multiple layers that include a common gas chamber and a reference gas chamber respectively configured to receive an exhaust gas and a reference gas;
a Nernst cell exposed to the common gas chamber and the reference air chamber, the Nernst cell configured to provide a reference signal indicative of an oxygen difference between the common gas chamber and the reference gas chamber;
an oxygen electrochemical pump cell exposed to the common gas chamber and configured to provide an oxygen signal indicative of an oxygen only concentration;
a gas electrochemical cell exposed to the common gas chamber and the reference gas chamber and configured to provide a gas signal indicative of a gas concentration; and
a processor in communication with the Nernst cell and the oxygen electrochemical pump cells, the processor includes a pulsation module configured to provide a positive and a negative excitation voltage to the gas electrochemical cell for a duration, each of the positive and the negative excitation voltages followed by a decay curve indicative of the gas concentration.

2. The sensor system of claim 1, wherein the duration is in a range of 5-50 msec, and an interval between the positive and the negative excitation voltages is in a range of 100 msec to 10 sec.

3. The sensor system of claim 1, wherein the excitation voltage is in a range of +/−2-2.5 V and no larger than an electrochemical electrolysis voltage of the gas electrochemical pump cell material system at a fixed frequency.

4. The sensor system of claim 1, wherein the oxygen pump electrode in the common gas chamber uses electrode materials that least dissociate oxygen from NOx electrolytically.

5. The sensor system of claim 4, wherein the oxygen electrochemical pump cell includes an oxygen-only pump electrode in the common gas chamber, supported on one side of a first layer of the multiple layers, and a counter oxygen pump electrode supported on an opposite side of the one side of the first layer.

6. The sensor system of claim 5, wherein the Nernst cell includes EMF oxygen sensing electrode and reference electrode arranged on opposing sides of a second layer of the multiple layers, the EMF oxygen sensing electrode arranged in the common gas chamber, and the reference electrode arranged in the reference gas chamber.

7. The sensor system of claim 6, wherein the oxygen-only pump electrode and the EMF oxygen sensing electrode share a ground.

8. The sensor system of claim 6, comprising a heater arranged adjacent to the Nernst cell, wherein the processor is configured to provide a fixed frequency excitation voltage feed into the Nernst cell to obtain the electrolyte impedance between the EMF and reference electrodes and provide a feedback control signal to modulate electrical power to the heater.

9. The sensor system of claim 6, wherein the processor is configured to control a voltage to the oxygen-only electrochemical pump cell based upon the EMF reference signal from the Nernst cell.

10. The sensor system of claim 4, comprising a gas diffusion-limiting aperture provided in at least one of the multiple layers and in fluid communication with the common gas chamber, the gas diffusion-limiting aperture configured to regulate an amount of exhaust gas into the common gas chamber.

11. The sensor system of claim 10, wherein the common gas chamber is configured to have a constant ratio of nitrogen monoxide and nitrogen dioxide.

12. The sensor system of claim 10, wherein common gas chamber is configured to be free from hydrocarbons and carbon monoxide.

13. The sensor system of claim 12, wherein the gas diffusion-limiting aperture includes precious metals as catalysts.

14. The sensor system of claim 1, wherein the counter oxygen pump electrode of the oxygen pump cell is exposed to the exhaust or air reference gas.

15. The sensor system of claim 1, comprising a ceramic metal heater arranged in the multiple layers adjacent to the Nernst cell, and the processor is configured to measure an initial drop of voltage in the Nernst cell or the electrochemical cell immediately after the excitation voltage, the voltage drop corresponding to an ohmic drop in electrolyte impedance that is used by the processor to modulate power to the ceramic metal heater.

16. The sensor system of claim 15, comprising a wire pigtail with six wires electrically connected to the Nernst cell, the oxygen electrochemical pump cell and the gas electrochemical cell and the heater.

17. The sensor system of claim 1, comprising a heater arranged in the multiple layers arranged adjacent to the Nernst cell, wherein the sensing element includes an ammonia electrochemical mixed potential cell and a nitrogen dioxide electrochemical mixed potential cell arranged in the multiple layers and respectively configured to provide NH3 and NO2 signals.

18. The sensor system of claim 17, comprising a wire pigtail with only eight wires electrically connected to the sensor element.

19. The sensor system of claim 17, wherein the processor is configured to output a difference between the NO2 and NOx signals and provide a nitrogen monoxide concentration.

20. The sensor system of claim 1, comprising a controller in communication with the process and configured to command at least one of a fuel system, an emissions system, and an engine control device in response to the NOx concentration.
